(19) United States
(12) Patent Application Publication
(10) Pub. No.: US 2016/0158770 A1
(43) Pub. Date: Jun. 9, 2016

(54) GAS DISTRIBUTOR AND METHOD OF USE THEREOF

(71) Applicants: Weldon Lee Ransbarger, Cypress, TX (US); Lee David Rhyne, Cypress, TX (US)

(72) Inventors: Weldon Lee Ransbarger, Cypress, TX (US); Lee David Rhyne, Cypress, TX (US)

(73) Assignee: Chevron U.S.A. Inc., San Ramon, CA (US)

(21) Appl. No.: 14/560,257

(22) Filed: Dec. 4, 2014

(51) Int. Cl. B05B 1/00; B01D 53/04; C10L 3/10

(52) U.S. Cl. CPC B05B 1/005; C10L 3/106; C10L 3/101; B01D 53/04; C10L 2290/542; B01D 2257/602

(57) ABSTRACT

A gas flow directing device to provide uniform gas flow into or out of a vessel having molecular sieve material contained therein and methods for treating a gas streams in the vessel using the gas flow directing device are described. The gas flow directing device includes a truncated cone having a cone base having an opening centered therein and a truncated top. The truncated cone further includes a gas permeable wall portion between the cone base and the truncated top having open sides to provide fluid communication between the opening in the cone base and space surrounding the gas permeable wall portion.

### FIELD

The present disclosure relates to a device for uniformly distributing gas being introduced into a vessel, and to methods for use thereof.

### BACKGROUND

Gas processing units are commonly made up of a vessel having an inlet and an outlet and containing molecular sieve material or other porous media depending on the desired effect on the gas. For instance, it is often necessary to subject gas to a dehydration step in order to remove water vapor. This is conventionally done by passing a gas feed through a vessel containing a bed of molecular sieve material known to be effective at adsorbing water molecules. Conventional vessel designs frequently do not distribute the gas feed uniformly across the bed. This can result in incomplete dehydration of the gas.

Similarly, the molecular sieve material used in a dehydration unit becomes saturated with water over time and must be regenerated to remove the water. During the regeneration of the molecular sieve material, conventional vessels designs do not distribute regeneration gas uniformly across the molecular sieve material. Conventional designs include a regeneration gas distributor consisting of a simple open pipe inlet or a vertical cylinder closed at the end and having open sides for introduction of regeneration gas into the vessel. The gas distribution provided by such devices often results in incomplete regeneration of the molecular sieve material. This can lead to operational problems. To overcome these problems, excess molecular sieve material has been added to the vessel to compensate for the incomplete regeneration.

It would be desirable to have a way to more uniformly distribute a gas feed in a vessel to avoid the aforementioned difficulties.

### SUMMARY

In one aspect, a gas flow directing device is provided for use in a vessel to provide uniform gas flow into or out of the vessel. The gas flow directing device includes a truncated cone having a cone base which can be a solid flat disc having a cone base radius and a cone base circumference and having an opening centered therein. The truncated cone also has a truncated top which can be a solid flat disc having a truncated top radius less than the cone base radius and a truncated top circumference. The truncated cone further includes a gas permeable wall portion between the cone base and the truncated top having open sides to provide fluid communication between the opening in the cone base and space surrounding the gas permeable wall portion.

In another aspect, a vessel is provided including vessel walls defining a vessel volume enclosed therein, a first opening in the top head of the vessel, and a second opening in the lower head of the vessel. The gas flow directing device is positioned within the vessel volume adjacent the second opening such that the opening in the cone base is aligned with the second opening and the truncated top of the flow directing device extends into the vessel volume.

In another aspect, a vessel is provided in which the gas flow directing device is positioned within the vessel volume adjacent the first opening such that the opening in the cone base is aligned with the first opening and the truncated top of the flow directing device extends into the vessel volume.

In another aspect, a method is provided for operating a process to remove a contaminant from a gas feed. The gas containing a contaminant is fed into the vessel which is at least partially filled with porous media capable of adsorbing or reacting with the contaminant, such that the gas flows between and through the porous media and at least a portion of the contaminant is removed from the gas by the porous media.

In another aspect, a method is provided for causing desorption of a molecular species from porous media in a vessel. A regeneration gas is fed into the vessel which is at least partially filled with porous media containing a molecular species, such that the gas flows between and through the porous media and at least a portion of the molecular species is desorbed from the porous media by the gas.

### DESCRIPTION OF THE DRAWINGS

These and other objects, features and advantages of the present invention will become better understood with reference to the following description, appended claims and accompanying drawings where:

FIG. 1 is a cross-sectional view illustrating a dehydration vessel according to one exemplary embodiment.

FIG. 2A-2E are various views illustrating a gas flow directing device according to an exemplary embodiment.

FIG. 3 is a perspective view illustrating a gas flow directing device according to another exemplary embodiment.

FIG. 4 is a perspective view illustrating a gas flow directing device according to another exemplary embodiment.

FIG. 5 is a perspective view illustrating a gas flow directing device according to another exemplary embodiment.

### DETAILED DESCRIPTION

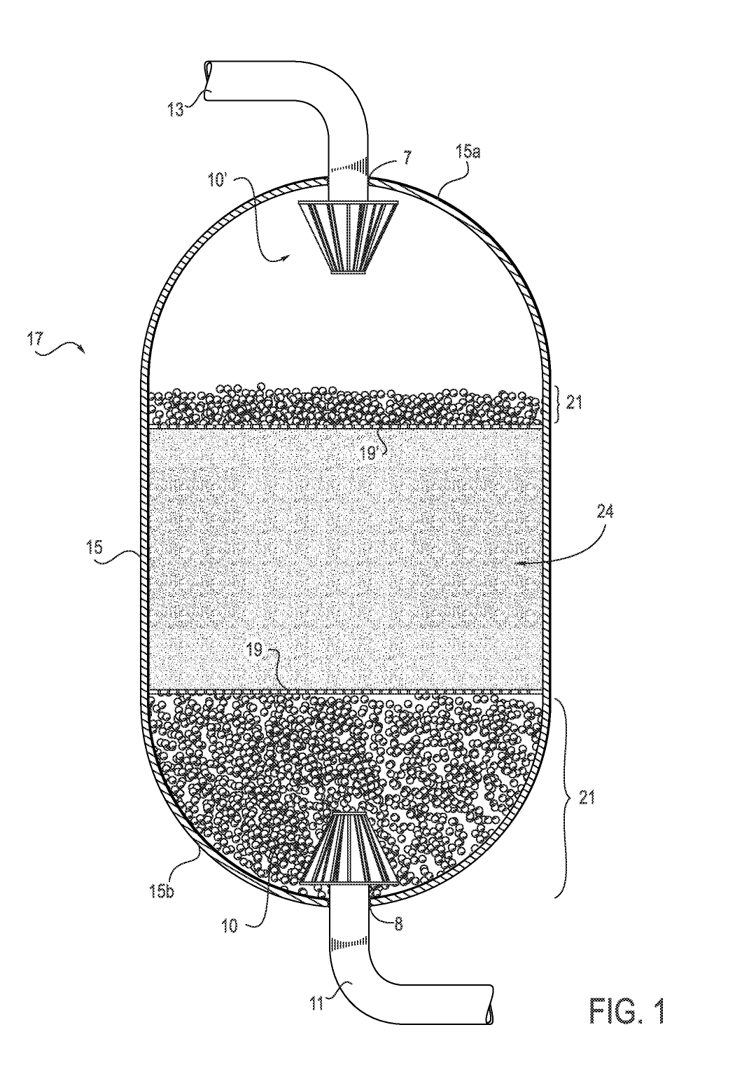

In one embodiment, a vessel 17 is provided as shown in FIG. 1. The vessel 17 has vessel walls that define an enclosed, interior vessel volume. The vessel walls include at least a substantially cylindrical portion 15 having an upper end and a lower end, a top head 15a for enclosing the upper end of the cylindrical portion and a lower head 15b for enclosing the lower end of the cylindrical portion. The top head 15a includes a first opening 7. The lower head 15b includes a second opening 8. In one embodiment, a gas distributor 10, to be described more fully hereinafter, is positioned within the vessel volume adjacent the second opening 8. In such embodiment, the gas distributor is positioned within the vessel such that the opening in the cone base is aligned with the second opening and the truncated top of the gas distributor extends into the vessel volume as shown. In another embodiment, a gas distributor 10′ having a design similar to gas distributor 10 is positioned within the vessel volume adjacent the first opening 7. Although the vessel is shown as vertically oriented, it can also be oriented horizontally, thus the terms “upper end,” “lower end,” “top head,” and “lower head” can also refer to the left-hand or right-hand ends or heads, respectively.

In one embodiment, the vessel 17 can contain at least one bed of porous media such as molecular sieve pellets 24 capable of adsorbing a component from a gas fed to the vessel. Inert ceramic balls 21 can be used to physically support the molecular sieve pellets 24. Optional floating screens 19 and/or 19′can be provided within the vessel to provide support and separation between the molecular sieve pellets 24 and the ceramic balls 21.

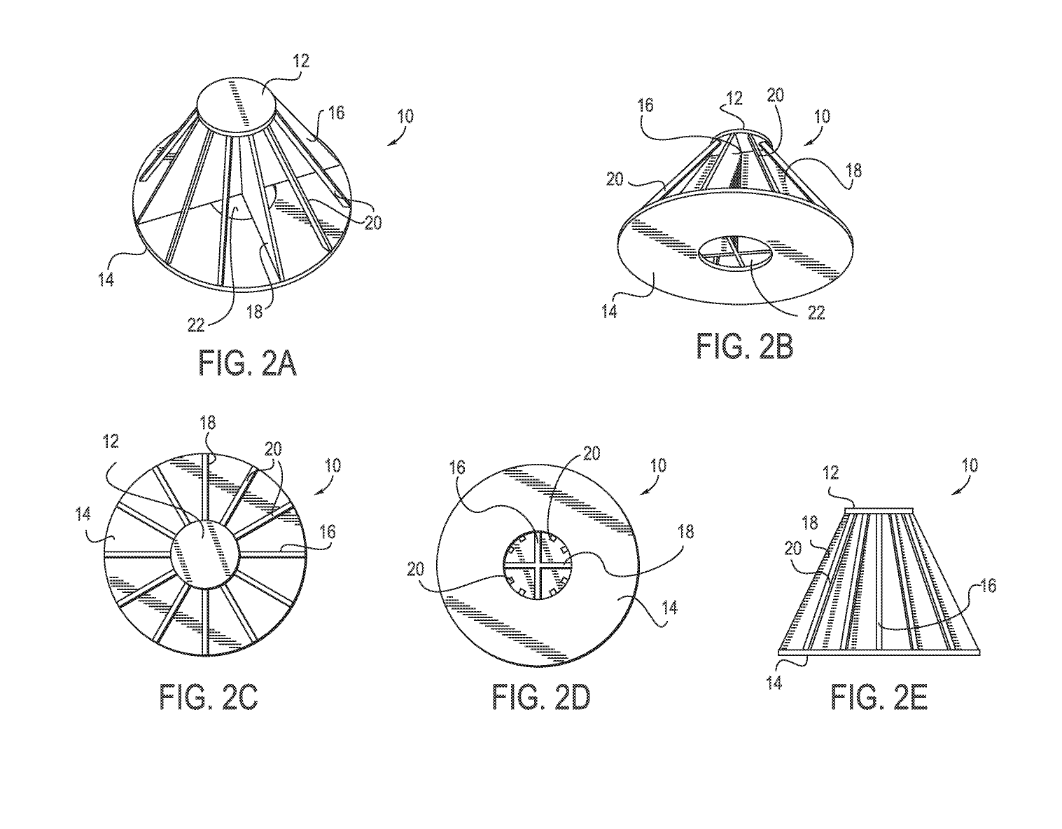

One embodiment of the gas distributor 10, also referred to as the gas flow directing device, is shown in FIGS. 2A-2E, showing the device from various angles. The gas distributor 10 can take the form of a truncated cone. The truncated cone has a cone base 14. The cone base can be a solid flat disc having a cone base radius and a cone base circumference and an opening 22 centered therein. The truncated cone also has a truncated top 12 which can be a solid flat disc having a truncated top radius less than the cone base radius and a truncated top circumference. The truncated cone has a gas permeable wall portion between the cone base and the truncated top. The gas permeable wall portion provides fluid communication between the opening 22 in the cone base and space surrounding the gas permeable wall portion of the gas distributor 10. As shown, the gas permeable wall portion can be defined by multiple ribs 20 extending between the circumference of the truncated top 12 and the circumference of the cone base 14.

Structural support for the gas distributor 10 can be provided by rigid structural supports such as supports 16 and 18 connecting the cone base 14 and the truncated top 12 as shown in

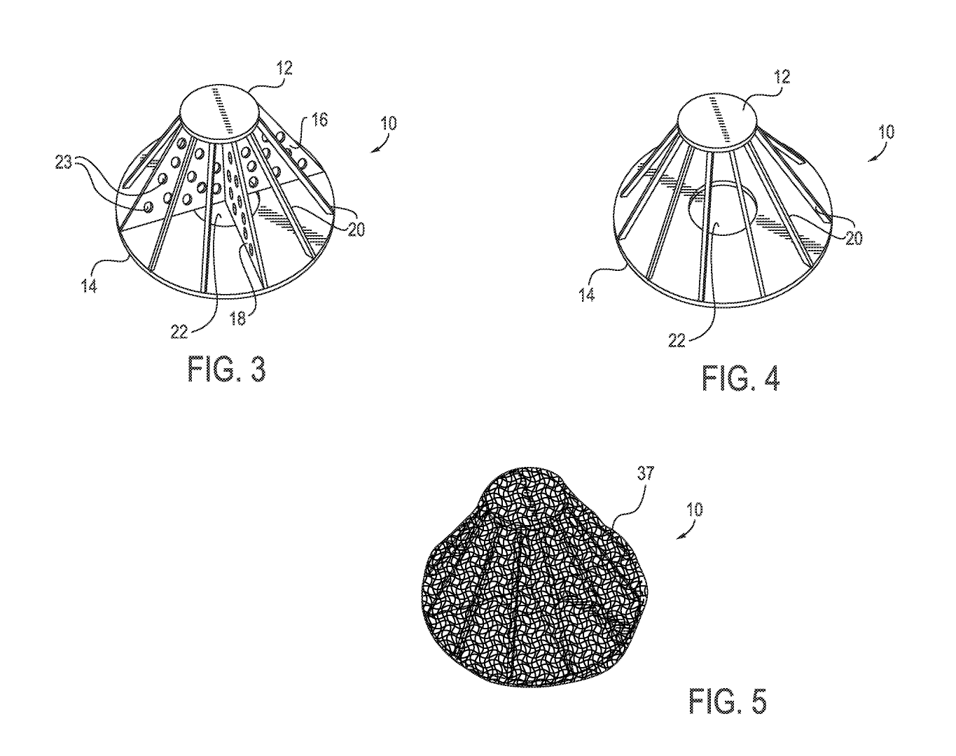

FIGS. 2A-2E. The rigid structural supports 16 and 18 can include perforations to allow the flow of gas there through. As shown in FIG. 3, the perforations can be holes 23 in the rigid support structures 16 and 18.

FIG. 4 illustrates one embodiment in which rigid support structures 16 and 18 are not used, in which case structural support is provided by the ribs 20.

In one embodiment, a gas permeable covering 37 can cover the gas distributor 10 as shown in FIG. 5. The gas permeable covering 37 is needed to prevent any solid particles from passing through the gas distributor. Any suitable screen, mesh or netting can be used. Gas permeable covering 37 need not resemble the illustration of FIG. 5. In one embodiment, the gas permeable covering 37 can include openings having an average diameter from 1 mm to 25 mm.

The vessel 17 can be used in a variety of process applications, as would be apparent to one skilled in the art. In general, the vessel is at least partially filled with porous media 24 having functionality appropriate for the specific process application, and a gas feed flows between and through the porous media.

At least one bed or layer of porous media 24 is used in the vessel 17. The porous media 24 can be any type of porous media used in a bed in a vessel as appropriate for the specific process application. For example, when the vessel is used as a dehydration vessel, molecular sieve pellets are used as a suitable porous media. When the vessel is used to remove a contaminant or specific molecular species from a gas, the porous media suitably contain a compound or material that reacts with the contaminant or adsorbs the contaminant or specific molecular species. The shape and form of the porous media 24, e.g. spheres, pellets, extrudates, particles, etc., is also according to the intended process application, as would be apparent to one skilled in the art.

Additional support material 21 can optionally be included in the vessel to directly contact and surround the gas distributor. The additional support material can be in the form of ceramic balls, pellets, extrudates and the like. The additional support material can be larger in average diameter than the porous media 24. The additional support material can provide further redistribution of the feed gas as well as to provide support for the porous media used in the bed as already described herein. The additional support material can be included when uniform distribution or collection of gas or vapor can impact bed performance. The additional support material can be either reactive or nonreactive to the gas flowing therethrough.

The gas flow directing device 10′ can be positioned within the vessel volume adjacent the first opening 7 such that the opening 22 in the cone base 14 is aligned with the first opening 7 and the truncated top 12 of the flow directing device 10′ extends into the vessel volume. Likewise, the gas flow directing device 10 can be positioned within the vessel volume adjacent the second opening 8 such that the opening 22 in the cone base 14 is aligned with the second opening 8 and the truncated top 12 of the gas flow directing device 10 extends into the vessel volume.

In one embodiment, the vessel 17 can be used as a dehydration vessel to remove water vapor from a natural gas feed. During normal operation mode, also referred to as dehydration mode, a feed stream of natural gas is provided at ambient temperature through pipe 13 to the top opening 7 and through the gas distributor 10′ into vessel 17. The gas feed then flows downwardly through the bed of molecular sieve pellets 24. Water vapor in the feed stream is adsorbed by the pellets 24, and dehydrated natural gas flows from the lower opening 8. During dehydration mode, the temperature can range from about 10 to about 100 degrees C. and a pressure can range from about 20 to about 100 bar(g). Over time, the molecular sieve pellets 24 become increasingly saturated with water and ineffective at adsorbing moisture, and the natural gas leaving the vessel 17 from the lower opening 8 contains an increasing amount of water vapor. The amount of moisture in the natural gas leaving the vessel can optionally be monitored by a sensor (not shown). When a predetermined maximum desired amount of moisture in the natural gas leaving the vessel is reached and optionally detected by the sensor, normal operation is discontinued, meaning the flow of feed gas is discontinued. At this point, operation is shifted to regeneration mode.

During regeneration mode, a feed stream of hot regeneration gas is provided to the lower opening 8 and flows upwardly through the molecular sieve pellets 24. Moisture from the pellets 24 is carried by the regeneration gas up and out of the vessel 17 through the top opening 7. During regeneration mode, the temperature in the vessel 17 can range from about 10 to about 500 degrees C. The regeneration gas has a temperature between about 150 and about 500 degrees C. The regeneration gas flows at a flow rate between about 10,000 and about 200,000 normal cubic meters per hour. Operation continues in regeneration mode until a predetermined desired amount of moisture in the regeneration gas leaving the vessel is reached, indicating that the molecular sieve pellets 24 have become dry to the point that the pellets 24 are effective at adsorbing moisture from the natural gas. At this point, operation switches to cooling mode in which cool gas at a temperature between about 10 and about 100 degrees C. is introduced to the vessel through lower opening 8 until the temperature within the vessel is sufficiently cooled to resume normal operation, i.e. cooled to a temperature between about 10 and about 100 degrees C.

In one embodiment, the vessel 17 and gas distributor 10 and/or 10′ can be used for pressure swing adsorption of species e.g. CO₂ or N₂ or numerous other species. During absorption mode, gas is fed into the vessel 17 through either the first opening 7 and gas distributor 10′ or the second opening 8 and gas distributor 10, depending on which of openings 7 and 8 is used as the inlet. The vessel 17 is at least partially filled with adsorbent porous media 24. As the gas flows between and through the porous media 24, at least one molecular species is adsorbed thus removing it from the gas.

During desorption mode, a process causes desorption of at least one of the molecular species from the adsorbent porous media 24 in the vessel 17. Gas is fed at a partial pressure lower than the pressure during absorption mode into either of the first opening 7 and gas distributor 10′ or second opening 8 and gas distributor 10. The gas flows between and through the porous media 24 and at least a portion of the molecular species is desorbed from the porous media 24 by the gas. Gas containing the desorbed molecular species is removed from the other of the first opening 7 or second opening 8, depending on which opening is used as the inlet and which is used as the outlet.

In one embodiment, the porous media 24 is used to remove mercury from a natural gas feed containing mercury. The porous media can contain a mercury removing material, including but not limited to, a sulfur containing compound, charcoal, amine sorbents and the like. In the case in which the porous media contains a sulfur containing compound, at least a portion of the mercury reacts with the sulfur containing compound to form a non-volatile mercury sulfide compound, and natural gas essentially depleted of mercury is removed from the second opening in the lower head of the vessel. The bed becomes full of mercury sulfide which is discarded in a safe manner.

It should be noted that only the components relevant to the disclosure are shown in the figures, and that many other components normally part of the systems described are not shown for simplicity.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

From the above description, those skilled in the art will perceive improvements, changes and modifications, which are intended to be covered by the appended claims.

What is claimed is:

1. A gas flow directing device for use in a vessel to provide uniform gas flow into or out of the vessel, comprising:
a truncated cone having:
a cone base comprising a solid flat disc having a cone base radius and a cone base circumference and having an opening centered therein; and
a truncated top comprising a solid flat disc having a truncated top radius less than the cone base radius and a truncated top circumference;
a gas permeable wall portion between the cone base and the truncated top providing fluid communication between the opening in the cone base and space surrounding the gas permeable wall portion.

2. The gas flow directing device of claim 1, further comprising a plurality of rigid structural supports connecting the cone base and the truncated top.

3. The gas flow directing device of claim 2, wherein the rigid structural supports are perforated.

4. The gas flow directing device of claim 1, further comprising a plurality of ribs connecting the cone base circumference and the truncated top circumference.

5. The gas flow directing device of claim 4, further comprising a gas permeable covering.

6. The gas flow directing device of claim 5, wherein the gas permeable covering comprises holes having a diameter from 1 mm to 25 mm.

7. A vessel comprising:
a. vessel walls defining a vessel volume enclosed therein, wherein the vessel walls comprise a substantially cylindrical portion having an upper end and a lower end, a top head for enclosing the upper end of the cylindrical portion and a lower head for enclosing the lower end of the cylindrical portion;
b. a first opening in the top head; and
c. a second opening in the lower head;
wherein the gas flow directing device of claim 1 is positioned within the vessel volume adjacent the second opening such that the opening in the cone base is aligned with the second opening and the truncated top of the flow directing device extends into the vessel volume.

8. A method for operating a process to remove a contaminant from a gas, comprising:
feeding a gas containing a contaminant into the first opening in the top head of the vessel of claim 7, wherein the vessel is at least partially filled with porous media capable of adsorbing or reacting with the contaminant, such that the gas flows between and through the porous media and at least a portion of the contaminant is removed from the gas by the porous media; and
removing the gas from the second opening in the lower head of the vessel.

9. The method of claim 8, wherein the gas fed into the first opening is natural gas to be dehydrated in the vessel and the contaminant comprises water vapor, wherein the porous media comprise molecular sieve pellets, and wherein dehydrated natural gas is removed from the second opening in the lower head of the vessel.

10. The method of claim 8, wherein the gas fed into the first opening is natural gas in the contaminant comprises mercury, wherein the porous media comprise a sulfur containing compound, and wherein at least a portion of the mercury reacts with the sulfur containing compound to form non-volatile mercury sulfide, and wherein natural gas essentially depleted of mercury is removed from the second opening in the lower head of the vessel.

11. A method for causing desorption of a molecular species from porous media in a vessel, comprising:
feeding a gas into the first opening in the top head of the vessel of claim 7, wherein the vessel is at least partially filled with porous media containing a molecular species, such that the gas flows between and through the porous media and at least a portion of the molecular species is desorbed from the porous media by the gas; and
removing the gas containing the desorbed molecular species from the second opening in the lower head of the vessel.

12. A vessel comprising:
a. vessel walls defining a vessel volume enclosed therein, wherein the vessel walls comprise a substantially cylindrical portion having an upper end and a lower end, a top head for enclosing the upper end of the cylindrical portion and a lower head for enclosing the lower end of the cylindrical portion;
b. a first opening in the top head; and
c. a second opening in the lower head;
wherein the gas flow directing device of claim 1 is positioned within the vessel volume adjacent the first opening such that the opening in the cone base is aligned with the first opening and the truncated top of the flow directing device extends into the vessel volume.

13. A method for causing desorption of a molecular species from a bed material in a vessel, comprising:
feeding a gas into the second opening in the lower head of the vessel of claim 12, wherein the vessel is at least partially filled with porous media containing a molecular species, such that the gas flows between and through the porous media and at least a portion of the molecular species is desorbed from the porous media by the gas; and
removing the gas containing the desorbed molecular species from the first opening in the top head of the vessel.

14. The method of claim 13, wherein the gas fed into the second opening is regeneration gas having a temperature between about 150° C. and about 500° C., wherein the porous media comprise molecular sieve pellets containing adsorbed water, and wherein the regeneration gas and water vapor are removed from the first opening in the top head of the vessel.
